(19) United States
(12) Patent Application Publication
(10) Pub. No.: US 2026/0159404 A1
(43) Pub. Date: Jun. 11, 2026

(54) LITHIUM RECOVERY THROUGH REVERSIBLE FATTY ACID PRECIPITATION

(71) Applicant: UCHICAGO ARGONNE, LLC, Argonne, IL (US)

(72) Inventors: Eva ALLEN, Berwyn, IL (US); A.H.M. Golam Hyder, Darien, IL (US); Albert L. Lipson, Oak Park, IL (US)

(73) Assignee: UCHICAGO ARGONNE, LLC, Argonne, IL (US)

(21) Appl. No.: 19/407,626

(22) Filed: Dec. 3, 2025

Related U.S. Application Data
(60) Provisional application No. 63/728,363, filed on Dec. 5, 2024.

(51) Int. Cl. C01D 15/02; B01D 61/42; C01D 1/30; C01D 1/38; C01D 1/40; C22B 3/44; C22B 26/12; H01M 10/54

(52) U.S. Cl. CPC C01D 15/02; B01D 61/422; C01D 1/30; C01D 1/38; C01D 1/40; C22B 3/44; C22B 26/12; H01M 10/54

(57) ABSTRACT

Described herein is a method for selectively recovering lithium cations from an aqueous solution; the method comprising the steps of: (a) adding a fatty acid composition comprising oleic acid to an aqueous salt solution comprising lithium cations and monovalent cations of at least one other metal besides lithium, to thereby form an aqueous fatty acid-salt mixture; (b) adjusting the pH of the mixture from step (a) to a pH in the range of about 8.5 to about 11.5, by adding an aqueous base to the mixture, thereby selectively forming a lithium fatty acid precipitate comprising lithium oleate; (c) separating the precipitate formed in step (b) from an aqueous supernatant comprising the cations of the at least one other metal and cations of the aqueous base; and (d) recovering the precipitate from step (c).

### CROSS-REFERENCE TO RELATED APPLICATIONS

This application claims the benefit of U.S. Provisional Application Ser. No. 63/728,363 filed on Dec. 5, 2024, which is incorporated herein by reference in its entirety.

### STATEMENT OF GOVERNMENT INTEREST

The United States Government has rights in this invention pursuant to Contract No. DE-AC02-06CH11357 between the United States Government and UChicago Argonne, LLC representing Argonne National Laboratory.

### FIELD OF THE INVENTION

This invention relates to methods for selectively recovering lithium from lithium-containing solutions.

### BACKGROUND

Lithium (Li) is a vital component for batteries with high energy density needed for all-electric vehicles and grid-scale storage for renewable energy generation. It is also critical in producing glass, ceramics, pharmaceuticals, and other materials. The demand and production of Li are driven by the rapidly expanding growth in electric vehicle production as countries aim to fully convert to an all-electric vehicle economy in the next 10-20 years. Currently, the United States has 10% of the global Li sources, while most remain in Asia and South America. Thus, in a recent DOE Critical Materials Assessment, Li has been projected as a critical material due to its importance to energy and supply risk due to foreign reliance.

Developing more diverse domestic Li production is essential to overcoming the volatility of the Li supply, meeting market demand, and ensuring national security as we pursue decarbonization goals with the aim of achieving net-zero emissions by 2050. Targeting various sources of brines, including geothermal and continental sources, presents an opportunity to grow our domestic supply of Li. As an example, California's Salton Sea, a geothermal brine source, is estimated to have the capacity to produce 600,000 tons of lithium carbonate per year due to its high Li concentration of >200 ppm.

Current Li extraction and refining processes involve some combination of highly disruptive “open-pit” mining, time-intensive solar evaporation, and multistage precipitation. Unfortunately, due to the high percentage of sodium, >30% (typically >90%), present in these brines, contamination remains an issue due to the low selectivity between monovalent ions, such as Na⁺ and K⁺. These contamination issues lead to a need for additional processing steps and input chemicals in which solid waste products are generated.

There is an ongoing need for new methods to recover lithium from lithium-containing waste solutions, such as from natural lithium-containing brines, lithium battery recycling wastes, and the like. The methods described herein address this need.

### SUMMARY

The methods described herein involve the precipitation of a non-soluble Li-salt from an aqueous solution by adding a fatty acid composition, such as oleic acid, which is a liquid at room temperature, (preferably approximately 0.9 to about 1.1 molar equivalent of fatty acid based on the lithium concentration in the solution) at a pH of about 8.5 to about 11.5, e.g., by addition of an aqueous base, such as sodium hydroxide, to a mixture of the fatty acid composition and the aqueous solution comprising lithium ions. Lithium salts of the fatty acid composition (Li-FA) form a precipitate (e.g., predominately lithium oleate), which is filtered and washed with deionized (DI) water to remove contaminants of competing ions such as sodium and other monovalent ions. The wash water, which is rich in sodium, can be converted back into sodium hydroxide using known bipolar electrodialysis (BPED) techniques. This converted sodium hydroxide can be reused in the Li-FA precipitation for pH adjustment.

Other fatty acid compositions comprising solid saturated acids can be used similarly to liquid fatty acids such as oleic acid by heating an aqueous salt solution comprising lithium cations and monovalent cations of at least one other metal besides lithium, and saturated fatty acid to the fatty acid melting temperature (40-70° C.) before and during addition to thereby form an aqueous fatty acid-salt mixture.

The washed Li-FA precipitate can then be dissolved by adjusting the pH to less than about 3.0, e.g., by addition of aqueous acid, such as aqueous hydrochloric or sulfuric acid, to liberate fatty acids (e.g., oleic acid) and produce a soluble lithium salt (e.g., aqueous lithium chloride, lithium sulfate, or lithium bisulfate). Upon acidification, two distinct layers are formed, one composed of fatty acids, and the other composed of the aqueous lithium salt (e.g., LiCl, LiHSO₄, or Li₂SO₄). These layers can be effectively separated using gravity or membrane filtration techniques. The recovered fatty acids can be recycled for subsequent precipitation processes. The lithium salt can be converted to aqueous LiOH, and the counter ion of the lithium salt can be recovered as the corresponding aqueous acid (e.g., HCl or H₂SO₄) using BPED. The resulting aqueous LiOH can then be crystallized to yield battery-grade LiOH powder, suitable, e.g., for cathode synthesis.

The proposed precipitation process exhibits substantial benefits, such as exceptional scalability, surprising selectivity for lithium-FA precipitation over precipitation of FA salts of other monovalent ions (e.g., sodium or potassium), and requires significantly less energy when compared with conventional Li recovery methods. This innovative approach necessitates minimal additional chemicals in the process streams compared to traditional methods for recovering lithium. Recycling the recovered fatty acids, aqueous base, and aqueous acid back into the Li-FA precipitation process provides an environmentally friendly approach to lithium recovery. Following the recovery of fatty acids, a purified lithium salt solution is produced, which can then be directly converted to aqueous LiOH by BPED without the need for lithium-selective ion-exchange membranes in the BPED process. Instead, standard ion exchange membranes, which are cost-effective and readily available in the commercial market, are sufficient for producing battery-grade LiOH from the recovered lithium salt solution.

The following non-limiting embodiments are provided to illustrate certain aspects and features of the methods described herein.

Embodiment 1 is a method for selectively recovering lithium cations from an aqueous solution; the method comprising the steps of:
(a) adding a fatty acid composition to an aqueous salt solution comprising lithium cations and monovalent or divalent cations of at least one other metal besides lithium, to thereby form an aqueous fatty acid-salt mixture;
(b) adjusting the pH of the mixture from step (a) to a pH in the range of about 8.5 to about 11.5, by adding an aqueous base to the mixture, thereby selectively forming a lithium fatty acid precipitate comprising lithium oleate;
(c) separating the precipitate formed in step (b) from an aqueous supernatant comprising the cations of the at least one other metal and cations of the aqueous base; and
(d) recovering the precipitate from step (c).

Embodiment 2 is the method of embodiment 1, wherein about 0.7 to about 1.5 mol percent of the fatty acid composition is added to the aqueous solution in step (a), based on moles of the fatty acid composition and moles of lithium cations in the solution.

Embodiment 3 is the method of embodiment 1 or 2, wherein about 0.9 to about 1.1 mol ratio of the fatty acid composition is added to the aqueous solution, based on moles of the fatty acid composition and moles of lithium cations in the solution.

Embodiment 4 is the method of any one of embodiments 1 to 3, wherein the aqueous solution comprises about 100 ppm to about 2 percent by weight (wt %) lithium cations (e.g., 100 ppm to about 1.6 wt % Li cations).

Embodiment 5 is the method of any one of embodiments 1 to 4, wherein the fatty acid composition contains a saturated fatty acid, and preferably the fatty acid mixture is heated at or above its melting point in any or all of steps (a), (b), and (c).

Embodiment 6 is the method of any one of embodiments 1 to 5, wherein the fatty acid composition comprises unsaturated fatty acids with between 6 and 30 carbon atoms.

Embodiment 7 is the method of embodiment 6, wherein the unsaturated fatty acids include oleic acid.

Embodiment 8 is the method of embodiment 7, wherein the fatty acid composition comprises at least about 50 wt % of oleic acid, based on moles of oleic acid to total moles of fatty acids in the fatty acid composition.

Embodiment 9 is the method of embodiment 7, wherein the fatty acid composition comprises at least about 75 wt % of oleic acid, based on moles of oleic acid to total moles of fatty acids in the fatty acid composition.

Embodiment 10 is the method of embodiment 7, wherein the fatty acid composition comprises at least about 80 wt % of oleic acid percent of oleic acid, based on moles of oleic acid to total moles of fatty acids in the fatty acid composition.

Embodiment 11 is the method of any one of embodiments 1 to 10, wherein the aqueous solution in step (a) comprises up to about 800 times greater concentration of monovalent cations of the at least one other metal relative to lithium cations (e.g., at least about 750, 700, 650, 600, 550, 500, 540, 400, 350, 300, 250, 200, 150, 100, or 50 times greater concentration of other monovalent cations), and/or up to about 30 times greater concentration of divalent cations of the at least one other metal relative to lithium cations (e.g., at least about 25, 20, 15, 10, 5, 4, 3, or 2 times greater concentration of divalent cations).

Embodiment 12 is the method of any one of embodiments 1 to 11, wherein at least one other metal comprises sodium, and the aqueous solution in step (a) comprises up to about 800 times greater concentration of sodium cations relative to lithium cations (e.g., at least about 750, 700, 650, 600, 550, 500, 540, 400, 350, 300, 250, 200, 150, 100, or 50 times greater concentration of sodium cations).

Embodiment 13 is the method of any one of embodiments 1 to 12, wherein the precipitate comprises at least about 50 mol percent lithium oleate based on total moles of fatty acid in the precipitate, whereas the remaining percentage are other lithium fatty acid precipitates.

Embodiment 14 is the method of any one of embodiments 1 to 13, wherein the precipitate comprises at least about 80 mol percent lithium oleate based on total moles of fatty acid in the precipitate, whereas the remaining percentage are other lithium fatty acid precipitates.

Embodiment 15 is the method of any one of embodiments 1 to 14, wherein the precipitate comprises less than about 0.0005 mol percent of the cations of the at least one other metal, based on total moles of cations in the precipitate.

Embodiment 16 is the method of any one of embodiments 1 to 15, wherein the precipitate comprises less than about 0.0005 mol percent of the sodium cations, based on total moles of cations in the precipitate.

Embodiment 17 is the method of any one of embodiments 1 to 16, wherein the at least one other metal comprises sodium, potassium, calcium, and/or magnesium.

Embodiment 18 is the method of any one of embodiments 1 to 17, further comprising the additional steps of (e) adding a strong aqueous acid (e.g., HCl or sulfuric acid) to the precipitate recovered in step (d) thereby forming a mixture of an aqueous lithium salt of the acid and a second fatty acid composition comprising oleic acid; and then (f) separating the second fatty acid composition from the aqueous lithium salt of the acid.

Embodiment 19 is the method of embodiment 18, further comprising the additional step of (g) electrodialyzing the aqueous lithium salt of the acid from step (f) to thereby form an aqueous solution of lithium hydroxide and to reform and recover the aqueous acid.

Embodiment 20 is the method of embodiment 19, further comprising crystallizing the aqueous solution of lithium hydroxide to form solid lithium hydroxide.

Embodiment 21 is the method of any one of embodiments 1 to 20, further comprising electrodialyzing the supernatant from step (c) to reform and recover the aqueous base.

### BRIEF DESCRIPTION OF THE DRAWINGS

FIG. 1 illustrates the reaction of a lithium-containing aqueous solution with a fatty acid composition comprising oleic acid to form a precipitate comprising lithium oleate upon adjustment of the pH, e.g., to a pH of about 8.5 to about 11.5.

FIG. 2 provides a schematic process flow chart for an embodiment of the methods described herein.

FIG. 3 provides a plot of Li yield in the precipitate (in %) calculated from the removal of Li from the filtrate versus the ratio of moles of oleic acid to moles of Li in the reaction mixture for precipitation of lithium oleate by addition of aqueous sodium hydroxide to an aqueous LiCl/oleic acid mixture (100 ppm and 800 ppm of Li⁺). The optimum ratio of oleic acid to LiCl was about 0.9:1 to about 1.1 to 1 in this experiment, providing at least about 90% Li recovery in the precipitate.

FIG. 4 compares Li oleate precipitation from 1 g/L LiCl solutions through pH adjustment with sodium hydroxide addition. The volume of a 1 g/L LiCl solution was held constant while the 2M NaOH solution volume was adjusted. The precipitate was filtered, and further precipitate removal was performed through centrifugation for 30 min at 10000 rpm. The precipitate was unwashed, resulting in some Na content. It was found that 20% molar excess was needed to induce Li precipitation from the LiCl solution, adjusting the pH from 9.13 to 11.32.

FIG. 5 compares Li⁺ selectivity in solutions with increasing Na⁺ content. Slurries were filtered using a 2-micron filter paper, and the precipitate was washed three times with DI water. The extent of Li recovery in the precipitate was unaffected by Na content and effectively removed through washing, clearly demonstrating Li-selectivity.

FIG. 6 demonstrates oleic acid recovery through protonation with hydrochloric acid. A set amount of lithium oleate was used and hydrochloric acid concentration was varied at a set volume. The dashed line and right axis show the percent yield for lithium recovery, while the bar graphs and left axis provide the weight percent of lithium in the recovered lithium chloride solution.

FIG. 7 provides a plot of % yield of oleic acid recovery versus concentration of HCl after dilution, for recovery of oleic acid by acidification of the Li-FA product with aqueous HCl. As a follow-up to the results shown in FIG. 6, the ion concentration was kept steady, and the diluted slurry was adjusted with increasing DI water volumes. After liquid-liquid separation using a separatory funnel, it was found that dilution to a final HCl concentration of 0.35 M improves recovered oleic acid yields to >98%.

FIG. 8 provides plots of lithium precipitate yields and Na concentrations in the filtrates for precipitation of lithium oleate with oleic acid in two 150 ppm LiCl solutions containing two different concentrations of NaCl, i.e., 2250 ppm (15 molar Na/Li) and 3750 ppm (25 molar Na/Li).

FIG. 9 provides selectivity data for Li oleate precipitation in the presence of K and Na, providing Li, K, and Na levels (Mol %) for the initial brine, filtrate, wash water, and lithium oleate precipitate.

FIG. 10 shows results from ten cycles of repeated precipitation of Li and the subsequent recovery of oleic acid, demonstrating the stability of the oleic acid precipitant after multiple uses, including the recovery of oleic acid from lithium oleate (top) and the lithium concentration (ppm) in the filtrate and recovered LiCl solution (bottom).

### DETAILED DESCRIPTION

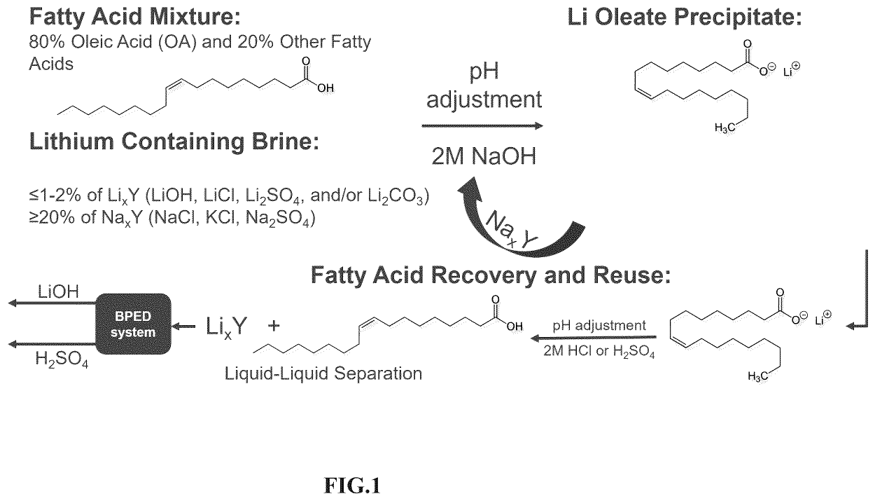

FIG. 1 illustrates the reaction of a lithium-containing aqueous solution with a fatty acid composition comprising oleic acid to form a precipitate comprising lithium oleate upon adjustment of the pH, e.g., to a pH of about 8.5 to about 11.5, followed by regeneration and recovery of the oleic acid and of a purified aqueous lithium cation-containing solution (e.g., aqueous LiCl). The precipitation has been proven selective to Li⁺ in the presence of transition metals Ni, Co, and Mn cations and alkali earth metals such as Mg²⁺ and Ca²⁺. These were tested at pH ranges up to about 11.5. At higher pH values above 12, the oleic acid undergoes saponification with the sodium hydroxide added to the pH adjustment, and thus does not completely separate from the aqueous phase. Li recovery has been demonstrated at or above 90% for solutions containing 100 ppm to 16000 ppm (1.6 wt %) of Li⁺ ions.

The oleic acid concentration in the fatty acid composition preferably is in the range of about 50 wt % or greater, and the amount of saturated fatty acids that are solids at room temperature (e.g., 20-25° C.) preferably is not more than 20 wt %. Other unsaturated fatty acids that are liquids at room temperature may also be present in the fatty acid composition and will also selectively precipitate Li. Solid saturated fatty acids containing one or more carboxylic acid functional group can be used in selective precipitation but both the fatty acid and solution containing Li need to be heated to the melting temperature of the saturated fatty acid.

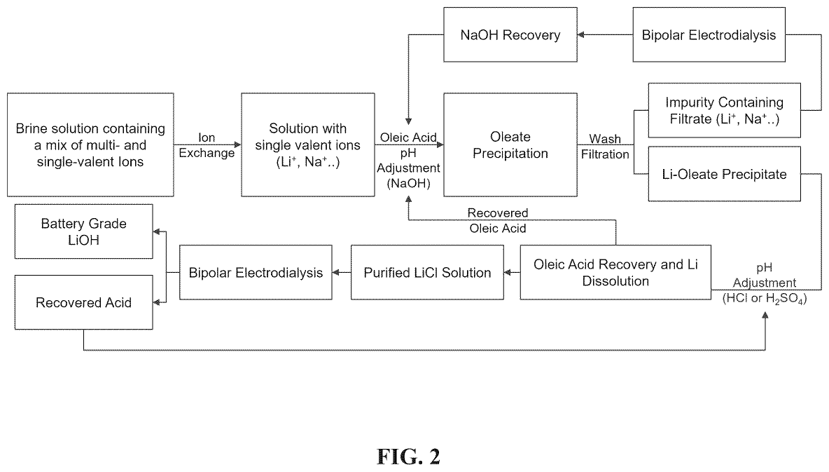

Described herein is a readily scalable and novel method for lithium (Li) recovery through precipitation using a plant-based, renewable fatty acid composition, such as those comprising oleic acid. This approach provides selective separation of Li⁺, particularly over other monovalent ions, such as Na⁺ and K⁺, which are typically present in brines. FIG. 2 illustrates a continuous version of the process. The fatty acid precipitation process is reversible through pH adjustment. Following the separation of the aqueous lithium salt (LiₓY) via a continuous gravity separator, the recovered fatty acid composition can be reused multiple times for subsequent Li-recovery processes. This process culminates in collecting a purified aqueous lithium salt (LiₓY) solution, where the specific anion Y is Cl⁻, CO₃²⁻, or SO₄²⁻. The resulting LiₓY (aq.) solution will undergo conversion into LiOH (aq.) using BPED. With the removal of competing monovalent ions from the brines, cost-effective standard ion exchange membranes can be employed in the electrodialysis process. Through recrystallization, battery-grade LiOH can be manufactured, which is suitable for synthesizing cathode materials for Li-ion batteries.

The described continuous process will significantly impact the goal of energy equity by replacing highly disruptive “open-pit” mining or evaporation ponds, which cause soil salinization, making soil infertile for agricultural use. The Li-recovery process described herein uses direct lithium extraction (DLE) practices, which will reduce land use and mitigate the enormous water consumption and groundwater depletion, allowing for minimal disruption to the deposits and surrounding communities. Additionally, the potential benefits include increased operational efficiency and reduced occupational hazards. The new technology provides new opportunities for the workforce to develop new technical and maintenance skills. The enhanced process sustainability will lead to improved community relations and promote economic development in regions rich in lithium deposits.

When pH is adjusted to a basic pH of about 8.5 to about 11.5, the precipitation of Li-ion (Li⁺) occurs via deprotonation of the fatty acids, such as oleic acid, in the fatty acid composition (i.e., removing H⁺ from the carboxylic acid groups of the fatty acids, forming a solid Li-FA precipitate, which is insoluble in the basic aqueous supernatant. The fatty acids may form other complexes with the competing monovalent ions in solution, such as Nat and K⁺, but those complexes are soluble in water, most likely due to the larger ionic radii of the other monovalent ions, resulting in reduced effective nuclear charge. These properties allow for high selectivity of fatty acid (particularly oleic acid) precipitation with Li⁺, allowing for contaminant removal through simple washing and filtration of the Li-FA precipitate. At a manufacturing scale, the wash water, mainly containing sodium chloride (NaCl) and sodium sulfate (Na₂SO₄), can be converted back into usable sodium hydroxide (NaOH) using the bipolar electrodialysis (BPED) process described above. In particular, this NaOH can be reused for pH adjustment for this process.

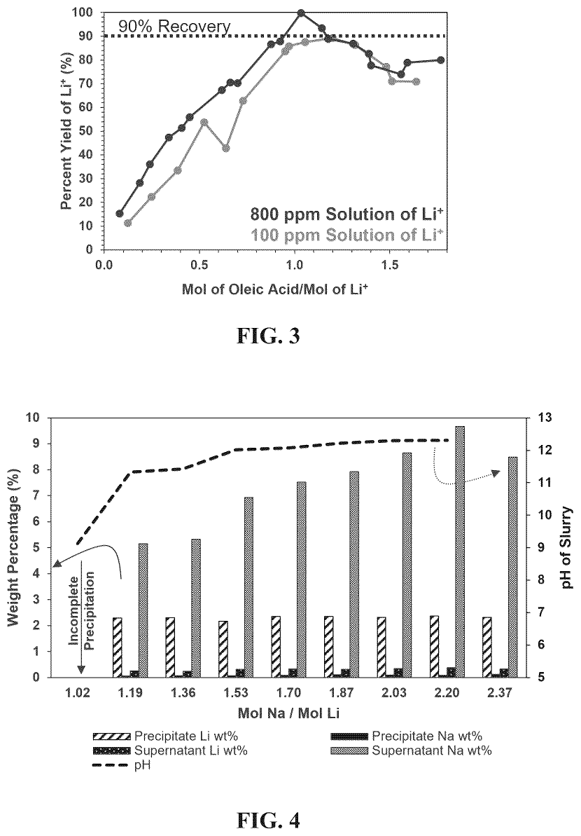

FIG. 3 provides a plot of Li yield in the precipitate (in %) calculated from the removal of Li from the filtrate versus the ratio of moles of oleic acid to moles of Li in the reaction mixture for precipitation of lithium oleate by addition of aqueous sodium hydroxide to an aqueous LiCl/oleic acid mixture (100 ppm and 800 ppm of Li⁺). The optimum ratio of oleic acid to LiCl was about 0.9:1 to about 1.1 to 1 in this experiment, providing at least about 90% Li recovery in the precipitate.

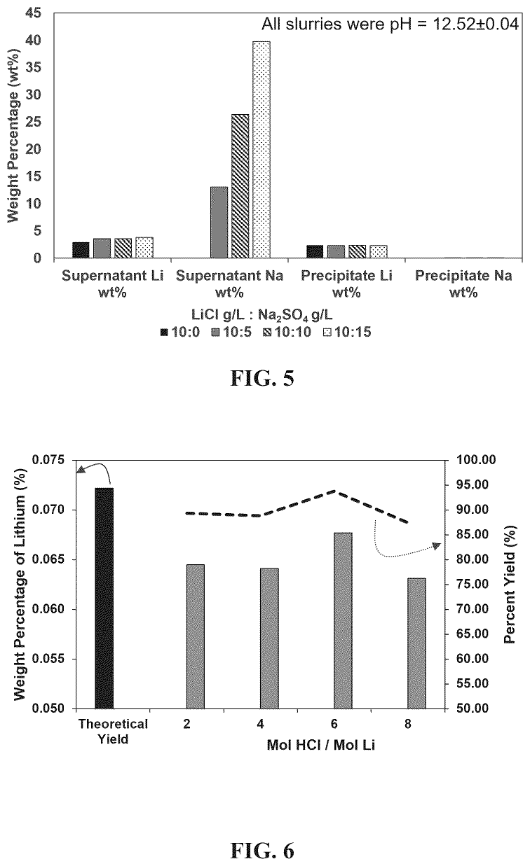

A series of studies were performed at the 200 mL batch scale to determine the sensitivity and selectivity of the Li-FA precipitation (see FIG. 4 and FIG. 5). The dotted line and right axis in FIG. 4 shows that when precipitating Li from a 1 g/L LiCl solution, a slight pH adjustment (such as with sodium hydroxide) is needed to form the Li-FA precipitate, which shows very little contamination. The bar graphs and left axis track the wt % of Na and Li in the unwashed Li-FA precipitate, and waste aqueous supernatant as measured by inductively coupled plasma optical emission spectrometry (ICP-OES). From these results, it is clear that the extent of Li recoverability does not change in the presence of higher concentrations of Na⁺. The selectivity of Li-FA precipitation is shown further in FIG. 5, in which increasing amounts of sodium sulfate were added, and the waste aqueous supernatant and Li-FA precipitate Li and Na contents were measured. The Li-FA precipitate was washed with DI water while filtering, resulting in increased Na⁺ content in the supernatant, trending with the original Na⁺ content in the feedstock. The Li-content in the Li-FA precipitate was unaffected by the increasing Na⁺ in the solution, and less than about 0.01 wt % Na⁺ remained in the Li-FA precipitate after washing. Some precipitated Li⁺ passed through the two-micron filter paper and can be recovered with improved filtration techniques.

For a continuous precipitation process, continuous stirred tank reactor (CSTR) can be used for the precipitation. These reactors are relatively simple in design and are widely used at large capacity in existing infrastructure for various manufacturing processes. The design consists of a jacketed tank for temperature control, inlets for reactant solutions delivered via pumps, an outlet for continuous collection via an overflow valve, and an overhead stirrer. For the process described herein, the brine feedstock is continuously pumped into the reactor alongside the fatty acid composition comprising oleic acid, and pH-adjusting base solutions. The rate of addition of the base solution is controlled by a pH controller in which the pH of the slurry is continually monitored. The resulting slurry containing the solid Li-FA precipitate and supernatant of other contaminating ions (Na⁺, K⁺, etc.) are collected and filtered through a commercial filter, such as a NUTSCHE filter dryer unit. The design of the NUTSCHE filter dryer is similar to the CSTR, with the addition of a stainless-steel mesh filter at the bottom outlet. In full-scale operation this step can either be done in multiple filter dryers in a semi-continuous fashion or using a continuous belt filter, which are similar to how cathode precursor materials for lithium batteries are filtered and dried today. The precipitate is filtered and washed with a DI water line while being stirred until contaminants are entirely removed, confirmed through conductivity measurements. Since the wash water and supernatant are rich in sodium, they can be recycled back into a purified form as usable sodium hydroxide (NaOH) pH buffer solution using BPED.

After removing contaminants (mainly Na⁺) through washing and filtering, relatively pure Li⁺ ions and fatty acids (primarily oleic acid) can be recovered from the solid Li-FA precipitate by acidifying the precipitate to protonate the fatty acid component and liberate lithium ion. Essentially complete protonation can be verified by Fourier Transform Infrared Spectrum (FTIR) of the recovered fatty acids compared to the virgin fatty acid composition and Li-FA precipitate. The appearance of a signal indicating the conjugate acid stretch in both virgin and recovered fatty acid indicates the complete protonation, which is absent in the solid precipitate. Initial studies of fatty acid (primarily oleic acid) and Li-recovery achieved about 90±3% Li recovery rate. For the continuous method, this process is performed in the same NUTSCHE filtration vessel under pH control.

Additionally, these studies explicitly show that the recovered fatty acids can be reused for further precipitation of lithium. The fatty acids can be easily separated from the aqueous lithium salt solution continuously using a gravity separator tank. The tank is designed to have the feed enter the tank and hit a diverter plate in which the rapid change in direction breaks the surface tension and begins the separation process. The aqueous solution settles at the bottom, and the fatty acids float. A barrier in the middle tank allows one part to collect only fatty acids through the overflow of the top layer. Valves on the bottom of the tank on either side of the barrier allow for the separation of the two solutions. The reusable properties of the fatty acid composition make the process fully circular and prevent additional solid waste generation present in other existing precipitation extraction methods. As the fatty acids are readily biodegradable, any loss of the fatty acid during the process would not pose a substantial environmental hazard. Initial studies did not indicate a drop in precipitation efficiency upon repeated use of the recovered fatty acid composition.

After separating the purified LiₓY (LiCl, Li₂SO₄, Li₂CO₃) solution, the LiₓY solution is converted to battery-grade LiOH salt. Initially, LiₓY is fed into the bipolar membrane electrodialysis (BPED) system to generate LiOH base and HCl or H₂SO₄ acid solution depending on the acid used for fatty acid recovery. Then, the LiOH base solution is converted to LiOH salt using a crystallization technique. As the LiOH solution prepared from the BPED system is close to battery-grade, single-step crystallization is sufficient instead of multiple-step crystallizations.

Current methods for producing LiOH from LiCl, Li₂CO₃, or Li₂SO₄ typically require using chemicals such as Na₂CO₃ and Ca(OH)₂ to produce Li₂CO₃ and LiOH, respectively. This conventional process generates CO₂ emissions from the production of Ca(OH)₂ and chemical wastes like NaCl and CaCO₃, which are costly in both financial and environmental terms.

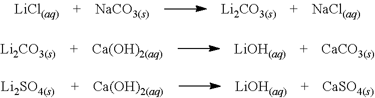

The benefits of using BPED include the minimization of chemical usage and a reduction in chemical waste generation. The BPED process can also be run without CO₂ emissions, assuming the electricity utilized is generated without CO₂ emissions. Additionally, the BPED system can produce up to 4 N pure hydrochloric acid (HCl) or sulfuric acid (H₂SO₄) as a byproduct, generating additional revenue for the overall process.

The BPED process is an electric field and concentration gradient-driven membrane separation technology in which bipolar and ion exchange membranes are used for water splitting and ion separation, respectively. The BPED system contains three main loops (or compartments): acid, feed, and base loops. It also has electrode rinse solution loops for continuous rinsing of anode and cathode surfaces, thereby maintaining a constant pH and controlling electrode deterioration. During the BPED process, a constant electrical voltage or current is applied, which leads to the migration of cations toward the cathode and anions toward the anode. The anions and cations are separated by an anion exchange membrane (AEM) and a cation exchange membrane (CEM). The BPED process is described in more detail in U.S. Pat. No. 7,632,387 to Hryn et al., assigned to UChicago Argonne, LLC (hereinafter “Argonne”), which is incorporated herein by reference in its entirety.

For instance, in a typical BPED unit operation, a pure LiCl feed solution containing Li⁺ and Cl⁻ ions is introduced into the feed supply loop. Under an electrical potential, bipolar membranes split water into H⁺ and OH⁻, which then migrate to the acid and base loops, respectively. Simultaneously, chloride ions (Cl⁻) of LiCl feed solution pass from the feed loop to the acid loop through an AEM to produce an HCl acid solution. At the same time, the Li⁺ ions of the LiCl feed solution pass from the feed loop to the base loop through a CEM to generate the LiOH base solution.

The BPED process can handle wash water generated from the process described herein, which contains mainly sodium chloride or sodium sulfate. This sodium chloride or sodium sulfate enriched wash water can also be introduced into the feed supply loop for converting into sodium hydroxide (NaOH) and either hydrochloric acid (HCl) or sulfuric acid (H₂SO₄) using the BPED process.

In a typical BPED operation, one of the significant challenges is that a substantial pH potential gradient develops across the membranes when the LiCl feed solution splits into acid (HCl) and base (LiOH) streams. This pH gradient becomes the driving force for proton (H⁺) diffusion or leakage. Afterward, these leaked protons move from the acid loop to the feed loop through AEM and then from the feed loop to the base loop through CEM, eventually decreasing LiOH concentration in the base loop. The BPED process developed at Argonne (U.S. Pat. No. 7,632,387 referred to above) uses a special type of AEM that blocks proton diffusion and thereby significantly improves energy efficiency and the maximum acid concentration attainable.

After the BPED processing, the obtained LiOH solution is further treated using a crystallization technique to isolate battery-grade LiOH·H₂O salt.

### EXAMPLE 1. LI PRECIPITATION VIA OLEIC ACID

### Materials and Molecular Weights:

| | |
|---|---|
| FILTEREDTRUFA fatty acid | Approximately 282.46 g/mol |
| (>80% Oleic Acid) | |
| Lithium Oleate | 288.39 g/mol |

Using a standard solution containing dissolved Li, the amount of oleic acid needed is calculated. The reaction preferably uses approximately 1:1 molar ratio of oleic acid to Li in solution. The reaction is as follows:

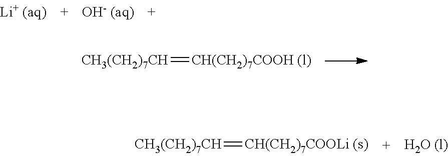

The reaction proceeds under basic pH>8.5 (preferably >pH 9). Standard solutions made with LiOH proceed without additional base addition; other anions (Cl⁻, SO₄²⁻, CO₃²⁻) require pH adjustment with a base like sodium hydroxide. Slurry typically is mixed overnight and filtered the next day through vacuum filtration with a Buchner funnel and side-arm flask. The filter paper used is 25 microns on the bottom and 0.2 or 0.45 microns of cellulose paper on the top. The lithium oleate precipitate (white/slightly yellow) is vacuum dried at about 80° C. overnight and weighed for yield. Filtrate is collected and submitted for ICP to determine the removal of Li content.

Recovery of Oleic Acid from Lithium Oleate:

The amount of HCl needed to dissolve the oleic acid is calculated based on the weight and molecular weight of the lithium oleate. A 2M solution of HCl and a 1:2 molar ratio of solid lithium oleate to HCl are used. The reaction is as follows:

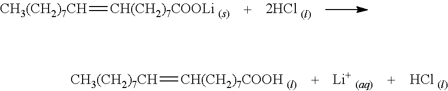

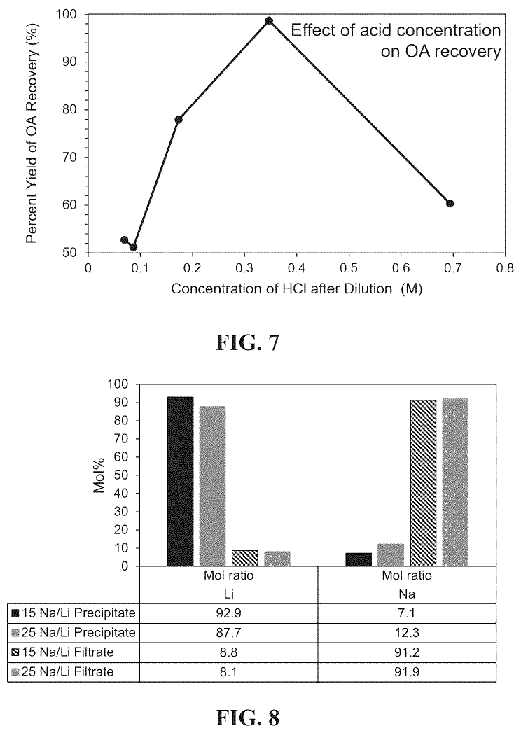

After combining the acid and the solid, the reaction mixture typically is diluted to a final concentration of about 0.35 M HCl (optimized via a study of varying liquid-to-solid ratios; see FIG. 7). The reaction mixture is stirred overnight or until lithium oleate is fully dissolved. Mixing efficiency will change the time of dissolution. After the lithium oleate is dissolved, an emulsion of oleic acid and aqueous lithium chloride is formed, which can be separated in a separatory funnel. The top layer is oleic acid.

FIG. 6 demonstrates oleic acid recovery through protonation with hydrochloric acid. A set amount of lithium oleate was used and hydrochloric acid concentration was varied at a set volume. The dashed line and right axis show the percent yield for lithium recovery, while the bar graphs and left axis provide the weight percent of lithium in the recovered lithium chloride solution. As shown in FIG. 6, a molar ratio of about 6:1 HCl to Li⁺ provided the highest percentage yield of Li⁺.

FIG. 7 provides a plot of % yield of oleic acid recovery versus concentration of HCl after dilution, for recovery of oleic acid by acidification of the Li-FA product with aqueous HCl. As a follow-up to the results shown in FIG. 6, the ion concentration was kept steady, and the diluted slurry was adjusted with increasing DI water volumes. After liquid-liquid separation using a separatory funnel, it was found that dilution to a final HCl concentration of 0.35 M improves recovered oleic acid yields to >98%.

### Lithium Precipitation Efficiency and Purity

Lithium precipitation with oleic acid from two 150 ppm LiCl solutions containing higher concentrations of NaCl, i.e., 2250 ppm (15 molar Na/Li) and 3750 ppm (25 molar Na/Li) were also evaluated. FIG. 8 demonstrates that the purity of the precipitates were 92.9 mol % and 87.7 mol %, respectively for the 2250 ppm and 3750 ppm solutions and that Na removal in the filtrates were 91.2 mol % and 91.9 mol %, respectively.

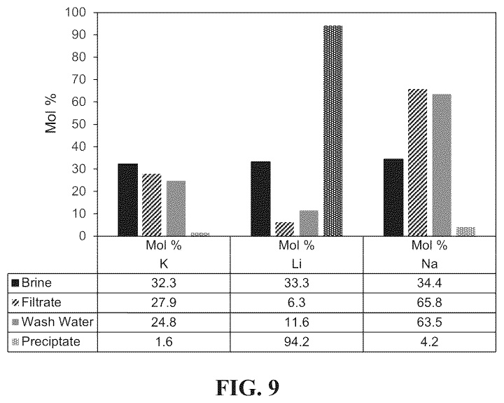

Li precipitation in the presence of additional monovalent ions with a chloride solution containing equal molar K and Na contents were evaluated as well. FIG. 9 provides selectivity data for Li precipitation in the presence of K and Na. The purity of the precipitate was as 94.2 mol %. The filtrate contained 65.8 mol % of Na and 27.9 mol % of K, with additional removal upon washing and refiltering or 63.5 mol % of Na and 24.8 mol % of K.

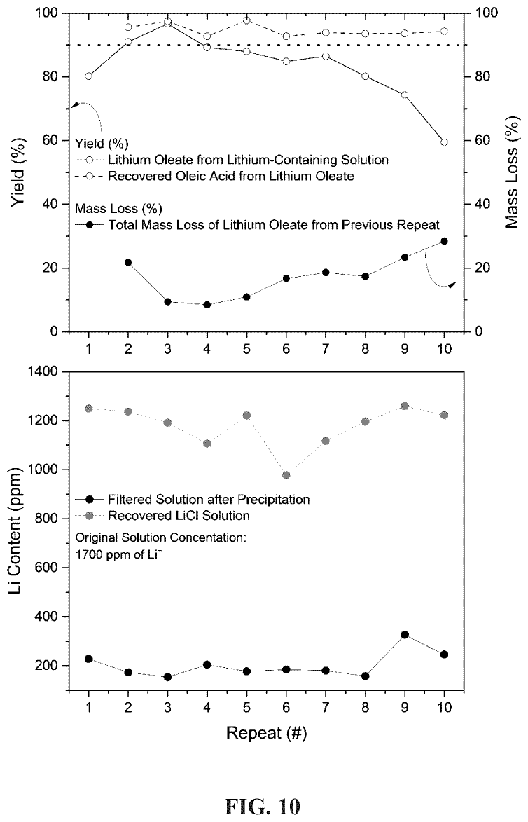

FIG. 10 shows ten cycles of repeated precipitation of Li and the subsequent recovery of oleic acid, demonstrating the stability of the oleic acid precipitant after multiple uses. The recovery of oleic acid from lithium oleate (FIG. 10, top) stayed above 90% each cycle, but the lithium oleate yield dropped below 90% once the mass was less than 10 g. This decline in yield is confirmed to be caused by mass loss during filtration, not degradation of the oleic acid, since the lithium concentration in the filtered solution after precipitation remained steady at 200 ppm, and the recovered LiCl solution after oleic acid regeneration averaged 1200 ppm (FIG. 10, bottom). Structural characterization of recovered oleic acid samples with proton NMR taken after five recovery cycles, showing no degradation of the oleic acid structure.

Any references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing materials or methods (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The terms “consisting of” and “consists of” are to be construed as closed terms, which limit any compositions or methods to the specified components or steps, respectively, that are listed in a given claim or portion of the specification. In addition, and because of its open nature, the term “comprising” broadly encompasses compositions and methods that “consist essentially of” or “consist of” specified components or steps, in addition to compositions and methods that include other components or steps beyond those listed in the given claim or portion of the specification. Recitation of ranges of values herein are merely intended to serve as a shorthand method of referring individually to each separate value falling within the range, unless otherwise indicated herein, and each separate value is incorporated into the specification as if it were individually recited herein. All numerical values obtained by measurement (e.g., weight, concentration, physical dimensions, removal rates, flow rates, and the like) are not to be construed as absolutely precise numbers, and should be considered to encompass values within the known limits of the measurement techniques commonly used in the art, regardless of whether or not the term “about” is explicitly stated. All methods described herein can be performed in any suitable order unless otherwise indicated herein or otherwise clearly contradicted by context. The use of any and all examples, or exemplary language (e.g., “such as”) provided herein, is intended merely to better illuminate certain aspects of the materials or methods described herein and does not pose a limitation on the scope of the claims unless otherwise stated. No language in the specification should be construed as indicating any non-claimed element as essential to the practice of the claims.

Preferred embodiments are described herein, including the best mode known to the inventors for carrying out the claimed invention. Variations of those preferred embodiments may become apparent to those of ordinary skill in the art upon reading the foregoing description. The inventors expect skilled artisans to employ such variations as appropriate, and the inventors intend for the claimed invention to be practiced otherwise than as specifically described herein. Accordingly, the claimed invention includes all modifications and equivalents of the subject matter recited in the claims appended hereto as permitted by applicable law. Moreover, any combination of the above-described elements in all possible variations thereof is encompassed by the claimed invention unless otherwise indicated herein or otherwise clearly contradicted by context.

The embodiments of the invention in which an exclusive property or privilege is claimed are defined as follows:

1. A method for selectively recovering lithium cations from an aqueous solution; the method comprising the steps of:
(a) adding a fatty acid composition to an aqueous salt solution comprising lithium cations and monovalent or divalent cations of at least one other metal besides lithium, to thereby form an aqueous fatty acid-salt mixture;
(b) adjusting the pH of the mixture from step (a) to a pH in the range of about 8.5 to about 11.5, by adding an aqueous base to the mixture, thereby selectively forming a lithium fatty acid precipitate comprising lithium oleate;
(c) separating the precipitate formed in step (b) from an aqueous supernatant comprising the cations of the at least one other metal and cations of the aqueous base; and
(d) recovering the precipitate from step (c).

2. The method of claim 1, wherein about 0.7 to about 1.5 mol percent of the fatty acid composition is added to the aqueous solution in step (a), based on moles of the fatty acid composition and moles of lithium cations in the solution.

3. The method of claim 1, wherein about 0.9 to about 1.1 mol ratio of the fatty acid composition is added to the aqueous solution, based on moles of the fatty acid composition and moles of lithium cations in the solution.

4. The method of claim 1, wherein the aqueous solution comprises about 100 ppm to about 2 percent by weight (wt %) lithium cations.

5. The method of claim 1, wherein the fatty acid composition contains a saturated fatty acid, and preferably the fatty acid mixture is heated at or above its melting point in any or all of steps (a), (b), and (c).

6. The method of claim 1, wherein the fatty acid composition comprises unsaturated fatty acids with between 6 and 30 carbon atoms.

7. The method of claim 6, wherein the unsaturated fatty acids include oleic acid.

8. The method of claim 1, wherein the fatty acid composition comprises at least about 50 wt % of oleic acid, based on moles of oleic acid to total moles of fatty acids in the fatty acid composition.

9. The method of claim 1, wherein the fatty acid composition comprises at least about 75 wt % of oleic acid of oleic acid, based on moles of oleic acid to total moles of fatty acids in the fatty acid composition.

10. The method of claim 1, wherein the fatty acid composition comprises at least about 80 wt % of oleic acid percent of oleic acid, based on moles of oleic acid to total moles of fatty acids in the fatty acid composition.

11. The method of claim 1, wherein the aqueous solution in step (a) comprises up to about 800 times greater concentration of monovalent cations of the at least one other metal relative to lithium cations, and/or up to about 30 times greater concentration of divalent cations of the at least one other metal relative to lithium cations.

12. The method of claim 1, wherein at least one other metal comprises sodium, and the aqueous solution in step (a) comprises up to about 800 times greater concentration of sodium cations relative to lithium cations.

13. The method of claim 1, wherein the precipitate comprises at least about 50 mol percent lithium oleate based on total moles of fatty acid in the precipitate, whereas the remaining percentage are other lithium fatty acid precipitates.

14. The method of claim 1, wherein the precipitate comprises at least about 80 mol percent lithium oleate based on total moles of fatty acid in the precipitate, whereas the remaining percentage are other lithium fatty acid precipitates.

15. The method of claim 1, wherein the precipitate comprises less than about 0.0005 mol percent of the cations of the at least one other metal, based on total moles of cations in the precipitate.

16. The method of claim 1, wherein the precipitate comprises less than about 0.0005 mol percent of the sodium cations, based on total moles of cations in the precipitate.

17. The method of claim 1, wherein the at least one other metal comprises sodium, potassium, calcium, and/or magnesium.

18. The method of claim 1, further comprising the additional steps of (e) adding a strong aqueous acid to the precipitate recovered in step (d) thereby forming a mixture of an aqueous lithium salt of the acid and a second fatty acid composition comprising oleic acid; and then (f) separating the second fatty acid composition from the aqueous lithium salt of the acid.

19. The method of claim 18, further comprising the additional step of (g) electrodialyzing the aqueous lithium salt of the acid from step (f) to thereby form an aqueous solution of lithium hydroxide and to reform and recover the aqueous acid.

20. The method of claim 19, further comprising crystallizing the aqueous solution of lithium hydroxide to form solid lithium hydroxide.

21. The method of claim 1, further comprising electrodialyzing the supernatant from step (c) to reform and recover the aqueous base.
